(19) United States
(12) Patent Application Publication
(10) Pub. No.: US 2013/0046767 A1
(43) Pub. Date: Feb. 21, 2013

(54) APPARATUS AND METHOD FOR MANAGING BUCKET RANGE OF LOCALITY SENSITIVE HASH

(71) Applicants: Ki-Yong LEE, Yongin-si (KR); Seok-Jin Hong, Hwaseong-si (KR)

(72) Inventors: Ki-Yong LEE, Yongin-si (KR); Seok-Jin Hong, Hwaseong-si (KR)

(21) Appl. No.: 13/325,452

(22) Filed: Dec. 14, 2011

(30) Foreign Application Priority Data
Aug. 18, 2011 (KR) 10-2011-0082416

(51) Int. Cl. G06F 17/30

(52) U.S. Cl. 707/747; 707/E17.052

(57) ABSTRACT

An apparatus for managing a bucket range of Locality Sensitive Hash is provided. The apparatus includes a range setting unit configured to set bucket ranges of Locality Sensitive Hash by dividing at least one vector based on distribution of data that are projected to the at least one vector.

### CROSS-REFERENCE TO RELATED APPLICATION

This application claims the benefit under 35 U.S.C. §119(a) of Korean Patent Application No. 10-2011-0082416, filed on Aug. 18, 2011, the entire disclosure of which is incorporated by reference for all purposes.

### BACKGROUND

1. Field

The following description relates to an apparatus and a method for managing a bucket range of Locality Sensitive Hash.

2. Description of the Related Art

With the development of information technology (IT), a great amount of data has been generated. In another aspect, with rapid development of computing power, storage capacity and computer networking, the amount of high dimensional multimedia data, which includes images, audio and video, is growing rapidly. Similarity Search is a technology for retrieving data that has a similarity to a query data among a large amount of high dimensional multimedia data. The Similarity Search is applicable to fields such as medical, environment, traffic etc., in addition to services such as image search, video search, audio search etc.

Locality Sensitive Hashing (LSH) may be used for Similarity Search of high dimensional data. The Similarity Search of high dimensional data represents a query of returning points that are near a query point in a high dimensional space. LSH provides a Similarity Search by indexing via a locality sensitive hash structure that maintains a locality of points in a high dimensional space.

### SUMMARY

In a general aspect, an apparatus for managing a bucket range of Locality Sensitive Hash is provided. The apparatus includes a range setting unit configured to set bucket ranges of Locality Sensitive Hash by dividing at least one vector based on distribution of data that are projected to the at least one vector.

The range setting unit may set the bucket range by dividing the at least one vector such that each bucket range comprises substantially the same amount of data.

The amount of data included in the each bucket range may correspond to a value of a total amount of data divided by a predetermined number of ranges.

The amount of data included in the bucket range may correspond to a predetermined amount input by a user.

The range setting unit may set the bucket range by dividing the vector based on statistic information including an average of distances between data projected to the at least one vector.

The apparatus may include a range adjusting unit configured to search for a region where an interval between data exceeds a predetermined threshold value and to adjust the bucket ranges based on the searched region.

The range adjusting unit may sequentially adjust the bucket ranges, starting from a first bucket range of the bucket ranges, and a bucket range to be adjusted and a next bucket range, which is adjacent to the bucket range to be adjusted, may be searched and the bucket range to be adjusted may be adjusted based on a region having data distributed by an interval exceeding a threshold value, the data comprised in the bucket range to be adjusted and the next range.

In response to the region where the interval between data exceeds the threshold value being more than one, the range adjusting unit may use a region where an interval between data exceeds the threshold value to a highest degree as a criterion of adjusting the bucket range.

The apparatus may include a data structure generating unit configured to generate a range information data structure for the bucket range.

The apparatus may include a bucket address output unit configured to output a bucket address with respect to a query data by a user using the range information data structure.

The bucket address output unit may include a hash value output unit configured to output hash values of the at least one vector based on the query data by the user, and a range search unit configured to return a sequence number of a bucket range corresponding to the output hash value by searching the range information data structure.

The apparatus may include a range update unit configured to initiate the range setting unit to reset the bucket range in response to a request being input by a user or a predetermined criterion being satisfied.

The predetermined criterion may be processed by periods of time.

The predetermined criterion may be processed in response to the amount of data comprised in the bucket range or the static information of data comprised in the bucket range exceeding a predetermined threshold value.

In another aspect, a method for managing a bucket range of Locality Sensitive Hash is provided. The method includes projecting data to at least one vector, and setting bucket ranges of Locality Sensitive Hash by dividing the at least one vector based on distribution of data that are projected to the at least one vector.

In the setting of the bucket range, the bucket range may be set by dividing the vector such that each bucket range comprises substantially the same amount of data.

In the setting of the bucket range, the bucket range may be set by dividing the at least one vector based on statistic information including an average of distances between data that are projected to the at least one vector.

The method may include searching for a region where an interval between data exceeds a predetermined threshold value and adjusting the bucket ranges based on the searched region.

In the adjusting of the bucket ranges, in response to the region where the interval between data exceeds the threshold value being more than one, a region where an interval between data exceeds the threshold value to a highest degree may be used as a criterion for adjusting the bucket range.

The method may include generating a range information data structure for the bucket ranges that have been set.

The method may include upon a query request by a user, processing a query using the range information data structure and returning a result in a form requested by the user.

The processing of the query may include outputting hash values of the at least one vector with respect to query data by the user, returning a sequence number of a bucket range corresponding to the output hash value by searching the range information data structure, and outputting a bucket address using the returned sequence number of the bucket range.

The projecting operation, the setting operation or a combination thereof may be implemented by hardware.

In yet another aspect, a non-transitory computer-readable storage medium for managing a bucket range of Locality Sensitive Hash includes a range setting unit configured to set bucket ranges of Locality Sensitive Hash by dividing at least one vector based on distribution of data that are projected to the at least one vector. Other features and aspects may be apparent from the following detailed description, the drawings, and the claims.

### BRIEF DESCRIPTION OF THE DRAWINGS

FIG. 1 is a diagram illustrating an example of an apparatus for managing bucket ranges of Locality Sensitive Hash.

FIG. 2A is a diagram illustrating an example of the bucket ranges of Locality Sensitive Hash of FIG. 1.

FIG. 2B is a diagram illustrating another example of bucket ranges that are set by adjusting the already set bucket range of Locality Sensitive Hash.

FIG. 3 is a diagram illustrating an example of searching bucket ranges of Locality Sensitive Hash of FIG. 1.

FIG. 4A is a diagram illustrating bucket ranges obtained using two hash functions according to a conventional Locality Sensitive Hashing (LSH) scheme.

FIG. 4B is a diagram illustrating bucket ranges obtained using two hash functions according to an example.

FIG. 5 is a flowchart illustrating an example of a method for setting bucket ranges of is Locality Sensitive Hash.

FIG. 6 is a flowchart illustrating an example of adjusting a bucket range of Locality Sensitive Hash.

FIG. 7 is a flowchart illustrating an example of updating a bucket range of Locality Sensitive Hash.

FIG. 8 is a flowchart illustrating an example of processing a query by searching bucket ranges of Locality Sensitive Hash.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Hereinafter, examples of an apparatus and a method for managing bucket ranges of Locality Sensitive Hash will be described with reference to accompanying drawings.

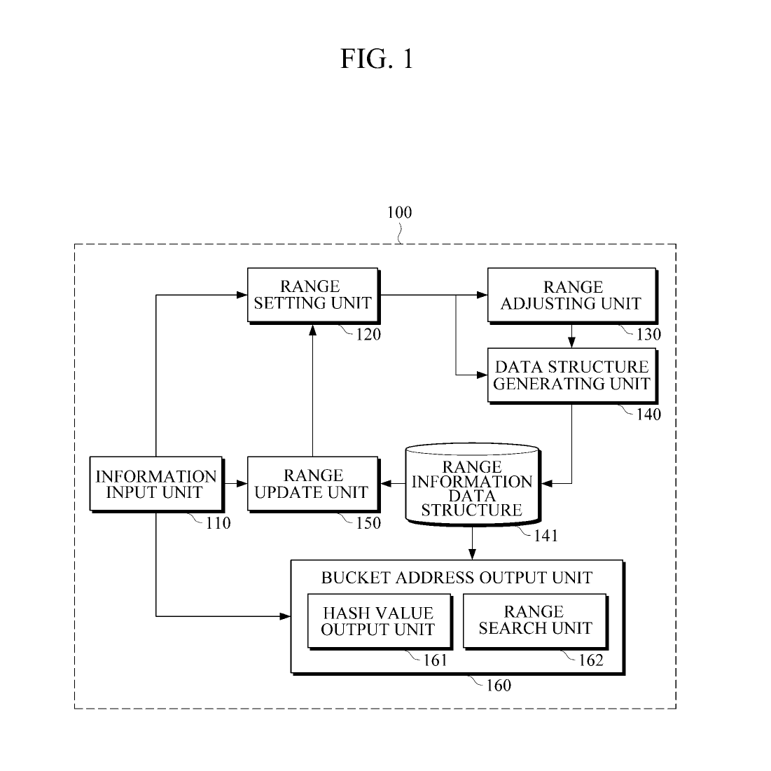

FIG. 1 illustrates an example of an apparatus for managing bucket ranges of Locality Sensitive Hash. Referring to FIG. 1, a Locality Sensitive Hash bucket range managing apparatus 100 includes a range setting unit 120.

The range setting unit 120 divides a vector based on distribution of data that are projected is to the vector in order to set bucket ranges of Locality Sensitive Hash. The vector may include at least one vector. At least one vector may represent k vectors (a₁, a₂, . . . and aₖ) that are randomly selected from a d-dimensional space. Some or all of the data may be obtained through sampling based on being projected onto vectors randomly selected from the k vectors.

Data projected to the vector may be distributed such that one region is more crowded with data than other regions and another region is more sparse with data than other regions. Based on such a distribution, the range setting unit 120 may divide the vector such that each bucket range includes the same amount of data in order to set the bucket ranges. In another aspect, the same amount of data to be included in each bucket range may be a predetermined amount that is input by a user. Based on Pre-processing and obtaining optimum number, the user may obtain the optimum amount of data for each range. According to another example, the same amount of data to be included in each bucket may be related to a value of the total amount of data divided by a predetermined number of bucket ranges. In other words, the Locality Sensitive Hash bucket range managing apparatus 100 may automatically calculate the amount of data to be included in each bucket range by dividing the total amount of data by a predetermined number of ranges that is input by a user. The amount of data to be included in each bucket range relates to Total amount of data divided by The number of ranges. The number of ranges input by a user may be extracted through a Pre-processing.

The above description is merely representational and the setting of the number of data to be included in each bucket is not limited to the above description. For example, the Locality Sensitive Hash bucket range managing apparatus 100 may set a criterion value at each level of total data number and may check the total amount of data periodically or real time. In response to the total number of data exceeding the criterion value, the Locality Sensitive Hash bucket range managing apparatus 100 may adjust the amount of data to be included in each range to a predetermined amount set at each level of the total amount of data.

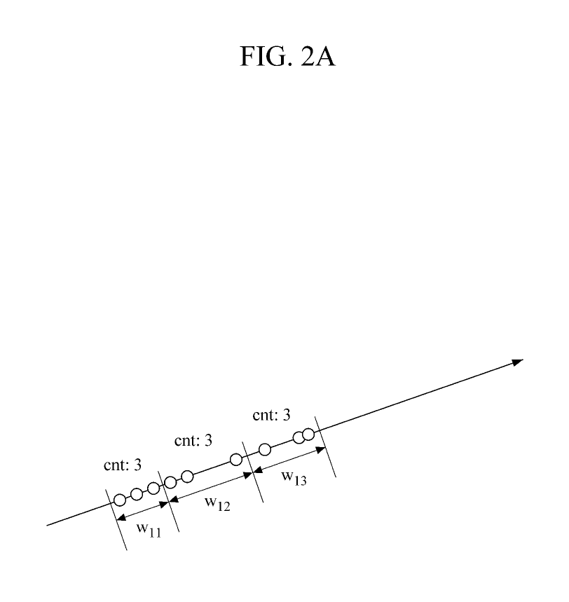

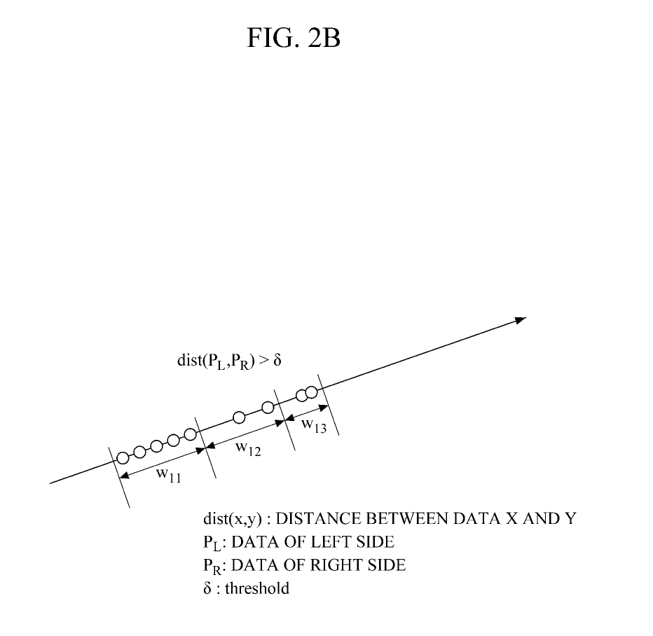

Thereafter, each vector is divided based on the above predetermined amount of data while searching data starting from a minimum amount of data to a maximum amount of data such that each range includes the predetermined amount of data. The predetermined amount of data is projected onto each vector. In this manner, the bucket ranges are set. FIG. 2A illustrates an example of bucket ranges of Locality Sensitive Hash of FIG. 1. Referring to FIG. 2A, a predetermined amount of data for each range in one vector relates to 3 and dividing the vector to which data are projected onto relate to setting the bucket ranges.

As another example, the range setting unit 120 sets bucket ranges based on dividing a vector based on statistic information about data projected to the vector. The statistic information may relate to the average of distances between data. In another aspect, the statistic information may relate to the average of distances between data, deviation of data and quartile of data. Pre-processing the entire data may improve the query processing performance, so that a user may output statistic information. Also, the user may use one of the output statistic information as a criterion value for dividing the bucket ranges. For example, the criterion value may correspond to the output statistic information providing the most effective query processing capability.

As another example, the Locality Sensitive Hash bucket range managing apparatus 100 may include a range adjusting unit 130. The range adjusting unit 130 may search for a sparse region where data are more sparsely distributed than in other regions and may perform adjusting on the bucket ranges based on the searched region. The sparse region represents a region where the interval between data exceeds a threshold value. In a case of dividing the bucket ranges based on a predetermined amount of data or statistic information, the buckets may be divided at a region where data is more concentrated than in other regions. In consideration of this, the adjustment of the bucket range may be performed such that the bucket ranges, which have been divided at the data concentrated region, are then divided at the data sparse region. In this case, is the range adjusting unit 130 may sequentially perform adjusting on the bucket ranges starting from the first bucket range among the bucket ranges. In another aspect, the range adjusting unit 130 searches a range to be adjusted and a next range, which is adjacent to the range to be adjusted, and performs adjusting based on a region having data distributed by an interval exceeding a threshold value in the range to be adjusted and the next range. In another aspect, the threshold value may correspond to a value that has been used to divide the bucket ranges of the Locality Sensitive Hashing (LSH). In yet another aspect, the threshold value may correspond to a value that is proportionally adjusted, or example, the optimum value that may be extracted through a Pre-processing.

In another aspect, first, a criterion bucket range to be adjusted is identified among previously set bucket ranges to readjust the buckets. The criterion bucket range maximally prevents data from being divided at a region having more concentrated data than in other regions. The criterion bucket range may relate to a bucket range to be adjusted among the previously divided buckets. The first bucket range to a range before the last range among all bucket ranges are sequentially set as the criterion bucket range to be adjusted. After a criterion bucket range s is set, a bucket range, which is adjacent to the criterion bucket range is searched. The bucket range may be searched based on the criterion bucket range to find a region having data distributed by an interval exceeding a predetermined threshold value. For example, in response to the first bucket range being determined as the criterion bucket range to be adjusted, the first bucket range and the second bucket range adjacent to the first bucket range, are searched to find a region having data distributed by an interval exceeding a predetermined threshold value. In response to a region having data distributed by an interval exceeding a threshold value existing in the criterion bucket range and the adjacent range, the first bucket range is adjusted based on the found region. The first bucket range may correspond to the criterion bucket range. This process continues until the last bucket range becomes the criterion bucket range. In response to is having no region with data distributed by an interval exceeding a threshold value in a criterion bucket region and a bucket region adjacent to the criterion bucket region, the criterion bucket region may not be adjusted and a next bucket range may be set as a criterion bucket region. The above process may subsequently be repeated.

Meanwhile, in response to a region having data distributed by an interval exceeding a threshold value being more than one, the range adjusting unit 130 uses a region having data distributed by an interval exceeding the threshold value to the highest degree as a criterion for adjusting the bucket range.

FIG. 2B illustrates another example of bucket ranges that are set by adjusting the already set bucket range of Locality Sensitive Hash. In response to the bucket ranges being divided based a predetermined number of data or statistic information (see FIG. 2A), the bucket utilization may be maximized. In another aspect, the division may occur at a data concentrated region over a bucket range w₁₁ and a bucket range w₁₂, the bucket range w₁₂ being adjacent to the bucket range w₁₁. In response to the division occurring at a data concentrated region, adjacent data may be included in different bucket ranges. Thus, based on this data distribution, the search precision may be reduced. In order to prevent the search precision from being reduced, the dividing of the data may be performed on a data sparse region based on the distribution of data. The data sparse region may relate to a region where the interval between data exceeds a threshold value.

In FIG. 2A, bucket ranges w₁₁, w₁₂, and w₁₃ are divided based on the number of data ‘three’ to be included in each bucket range. In another aspect, in FIG. 2B, the first bucket range w₁₁ among the bucket ranges w₁₁, w_{12,} and w₁₃ may be adjusted based on a region between the second data and the third data. The region may have data distributed by an interval exceeding a threshold value in the first bucket range wᵢᵢ and the second bucket range w₁₂. Similarly, the second bucket range w₁₂ among the bucket ranges w₁₁, w₁₂, and w₁₃ may be adjusted based on a is region between the first data and the second data of the third bucket range w₁₃ by searching the second bucket region w₁₂ and the third bucket range w₁₃ that follow the adjusted first bucket range w₁₁. The third bucket range w₁₃ becomes the last bucket range. As described above, in response to the division being performed based on a region having data distributed by an interval exceeding a threshold value, the possibility of dividing concentrated data on a vector is reduced. Referring to FIG. 2B, adjacent five data are not included in different bucket ranges but the adjacent five data are included in the same bucket range. The second bucket range includes two data and the third bucket range also includes two data.

As another example, the Locality Sensitive Hash bucket range managing apparatus 100 may further include a data structure generating unit 140 and a range information data structure 141. The data structure generating unit 140 may generate a range information data structure for the bucket range that is set by the range setting unit 120 or the bucket range that is adjusted by the range adjusting unit 130. The range information data structure 141 may be in a list form. In another aspect, the range information data structure 141 may be in the form of a table structure, a tree structure, a hash structure, and the like. The generated range information data structure may manage range information of the divided ranges, and may include meta information. The meta information may include information about the amount of data and statistic information for each bucket range. The range information data structure 141 storing the meta information may be used in response to insertion/update/deletion/query of data. The range information data structure, such as for example, a range information list, may be provided for each vector. Accordingly, the total number of range information lists is the product of the number (k) of vectors and the number (L) of hash tables. The information stored in the range information list may be meta information having a size smaller than that of a bucket of a hash table. Even in response to a disk storing the information of the range information list, the information of the range information list may not take up a large amount of disk space. In addition, the is information may be loaded on a memory, if necessary.

As another example, the Locality Sensitive Hash bucket range managing apparatus 100 may include a range update unit 150. The range update unit 150 may request the range setting unit 120 to reset the bucket ranges in response to a predetermined criterion being satisfied. The predetermined criterion may be checked in predetermined periods of time. In other words, the bucket ranges may be adjusted by considering data at a predetermined period of time where the data is inserted, updated or deleted during the predetermined period of time. As another example, the predetermined criterion may be set to be processed in response to the amount of data included in the bucket range or the static information of data included in the bucket range exceeding a predetermined threshold value. That is, the threshold value may be set by a user, and in response to the amount of data included in each bucket range exceeding the predetermined threshold value due to addition of new data or in response to the statistic information of data such as the average of distances between data and deviation of data being changed due to addition, deletion and update of data, the Locality Sensitive Hash bucket range managing apparatus 100 automatically resets the bucket ranges. As another aspect, the predetermined criterion is not limited thereto and may be set based on other conditions. For example, the predetermined criterion may be set such that the bucket ranges are updated whenever data is changed. For example, data is changed whenever an insertion, an update or a deletion of data occurs.

The range setting unit 120 may receive a request for range update from the range update unit 150 again sets the bucket ranges, and the data structure generating unit 140 regenerates the range information data structure 141 for the newly set bucket ranges.

In another example, the Locality Sensitive Hash bucket range managing apparatus 100 may include a bucket address output unit 160. With respect to a query data by a user, the bucket address output unit 160 may output a bucket address using the range information data structure 141. In other words, upon receiving a request for a query from a user, the bucket address output unit 160 outputs a bucket address of a bucket range corresponding to a user query data based on usage of the range information data structure 141. After the query is processed, the resulting bucket address is returned in the user requested form. In another aspect, the bucket address output unit 160 may include a hash value output unit 161 and a range search unit 162. With respect to the query data by the user, the hash value output unit 161 may output hash values of at least one vector. The range search unit 162 may return a sequence number of a bucket range corresponding to the output hash value based on searching the range information data structure 141. The bucket address output unit 160 outputs a bucket address based on usage of the sequence number returned from the range search unit 162. Meanwhile, the outputting of the bucket address based on usage of the range information data structure 141 may be used for processing a query request by a user and also for performing the Pre-processing on a great amount of high dimensional data.

According to a conventional Locality Sensitive Hash, with respect to a query data, a hash bucket address H(v) in a predetermined hash table is obtained as follows. A predetermined number of hash values h(v) are obtained, which correspond to the number (k) of hash functions, and the hash bucket address H(v) is obtained based on the hash values. For example, for a Locality Sensitive Hash using two hash functions h₁() and h₂() in response to a hash value of the hash function h₁() with respect to a predetermined data v being 0 and a hash value of the hash function h₂() with respect to the data v being 1, the bucket address with respect to the data v is H=(0, 1) in a predetermined hash table. This assumes that the sequence number of address starts from 0 at each vector. In another example, the hash values ‘0’ and ‘1’ of the hash functions h₁() and h₂() may be calculated by a predetermined equation and the bucket address is obtained based on the hash values. For example, the equation may be expressed by H=[(A predetermined number a1)*h₁()+(A predetermined number a2)*h₂()] modular (The maximum number of is buckets available in a single hash table).

In contrast to the conventional Locality Sensitive Hash, an example of processing a query based on usage of the range information data structure 141 is discussed below. That is, a hash value is obtained by performing inner production on a predetermined vector ‘a’ with respect to a query data ‘v’. Then, with respect to the obtained hash value and the obtained hash value, a value forming a hash bucket address is output based on the range information data structure 141. That is, with respect to query data by a user, the hash value output unit 161 of the bucket address output unit 160 may output at least one hash value based on the following equation.

### Equation

h_{a,b}=a·v+b

, where ‘a’ relates to a predetermined vector, ‘v’ relates to a query data of a user and ‘b’ relates to a constant.

Thereafter, the range search unit 162 may search the range information data structure via a binary search, a sequential search, a tree search, a hash search, etc. and may return a sequence number of a bucket range corresponding to the output hash value. The bucket address output unit 160 outputs the bucket address based on the returned sequence number.

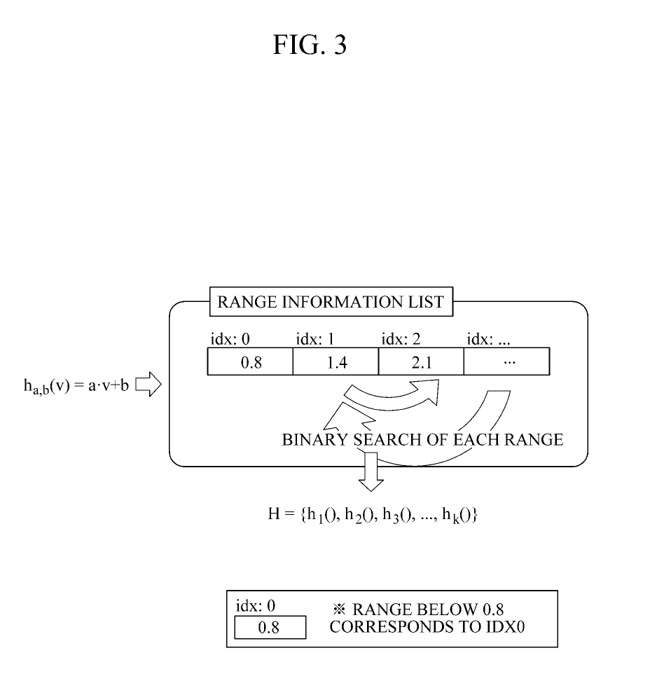

FIG. 3 illustrates an example of searching bucket ranges of Locality Sensitive Hash of FIG. 1. Referring to FIG. 3, in response to hash values of hash functions h₁, h₂, . . . hₖ being obtained as h₁()=0.7, h₂()=1.5, . . . , and hₖ()=1.1, respectively, a sequence number (idx) of each range is returned as 0, 2, . . . , and 1 with reference to the range information list. A value of each range in the range information list shown in FIG. 3 representing the end position at each range is assumed. Thereafter, the bucket address is obtained based on the returned value.

Finally, a data may be provided to the user in the form requested by the user. The data may be stored in the same address as the bucket address obtained with respect to the query data. For example, the requested form of data may represent ten units of data adjacent to the query or five units of data having a large similarity to the query. In order words, the bucket address output unit 160 may obtain a union of data and compare the union of data with the query, thereby providing the user with a result in the form requested by the user. The union of data may be included in buckets each corresponding to the same address as that of the bucket address output by the bucket address output unit 160.

According to another example, the Locality Sensitive Hash bucket range managing apparatus 100 may include an information input unit 110. The information input unit 110 may receive information input by a user and provide the user with a result. In other words, upon reception of a user request information for bucket setting, the information input unit 110 requests the range setting unit 120 to set the bucket ranges. Meanwhile, the information input unit 110 may receive additional information including the number of a predetermined data, the number of ranges to be divided and threshold value information that are used to set the bucket ranges. In response to the information input unit 110 receiving a query request and a query data from a user, the information input unit 110 sends the received request and query data to the bucket address output unit 160 to process the query.

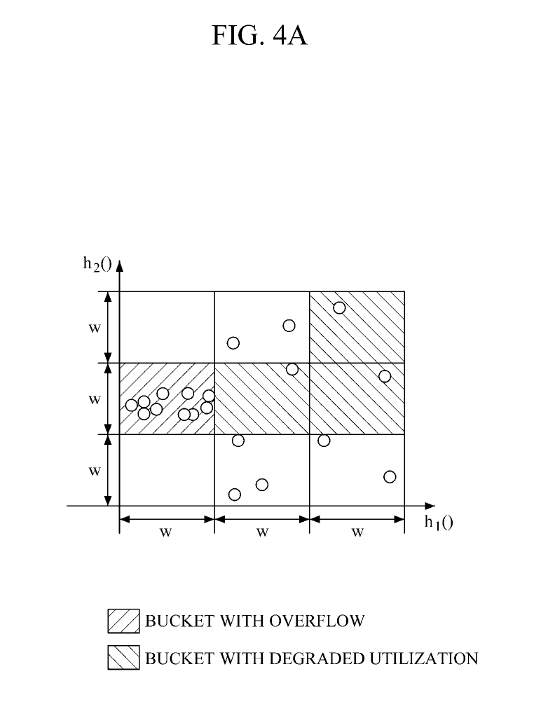

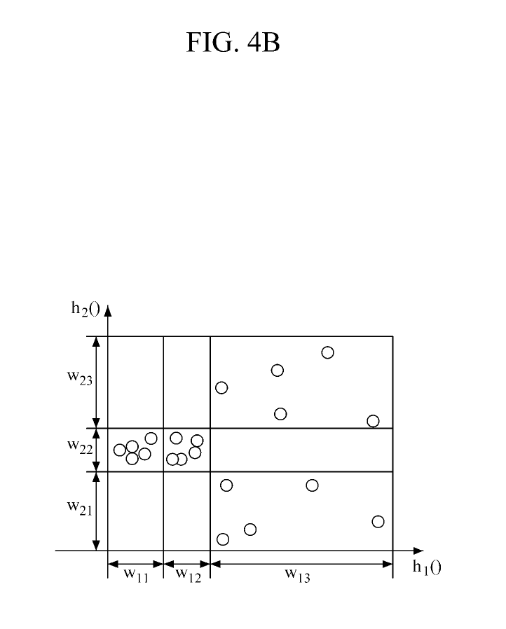

FIG. 4A illustrates bucket ranges obtained using two hash functions according to a conventional Locality Sensitive Hashing (LSH). FIG. 4A illustrates selecting predetermined two vectors h₁ and h₂ in a d-dimensional space and dividing each vector into portions each having a size of ‘w’ to obtain a two dimensional hash structure. Referring to FIG. 4A, in response to the distribution of data not being uniform, data may not be uniformly stored in the hash buckets. In other words, a bucket having data concentrated thereon exceeds its storage capacity. Thus, the bucket may require an allocation of an overflow bucket. The allocation of the overflow bucket at a query may degrade the performance of processing the query. In another aspect, a bucket having data sparsely distributed may degrade the utilization of the bucket because of an increase in the number of required storages used to manage the entire hash table.

FIG. 4B illustrates bucket ranges obtained using two hash functions according to an example. Referring to FIG. 4B, in response to the bucket ranges being divided based on the data distribution, the bucket ranges may not have the same size. In other words, the bucket ranges may have different sizes based on the data distribution. The different sizes may increase the efficiency of the buckets. Queries may be processed based on these bucket ranges having different sizes. Thus, the query processing may reduce the system resources required for data structure and query processing, and improve the performance of processing queries.

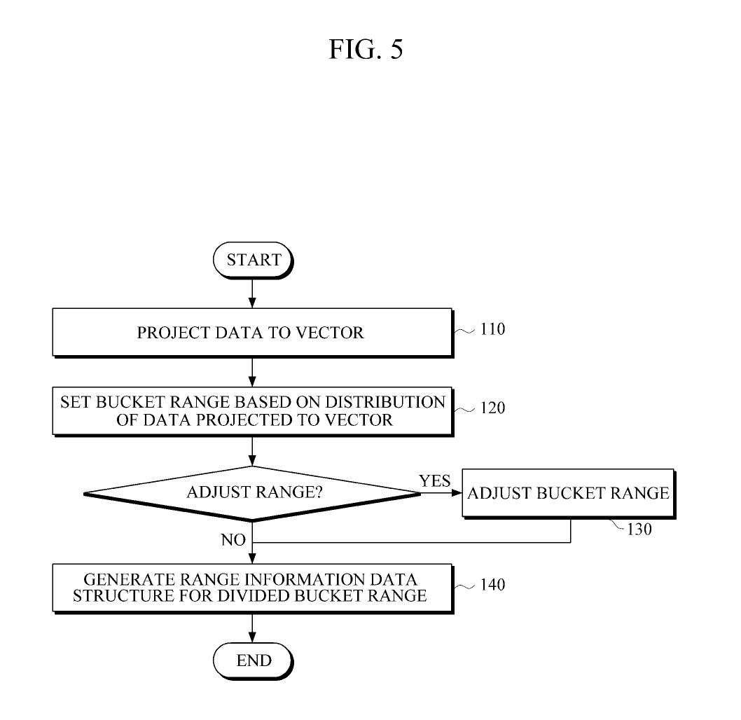

FIG. 5 illustrates an example of a method for setting bucket ranges of Locality Sensitive Hash. A Locality Sensitive Hash bucket range setting method included in a Locality Sensitive s Hash bucket range managing method may be as follows. Data are projected to at least one vector through inner product (110). The at least one vector may represent k vectors (h₁, h₂, . . . and hₖ) that are randomly selected in a d-dimensional space. Some or all of the data may be projected to the k vectors.

Thereafter, each vector is divided based on the distribution of the data that are projected to the vector. As a result of the division, the bucket ranges (120) may be set. According to an example, in operation 120 of setting the bucket ranges, the bucket ranges are set by dividing the bucket ranges such that each bucket range includes substantially the same amount of data. The data projected to the vector may be more densely distributed on one region than at other regions and more sparsely distributed on one other region. The same number of data included in each is bucket range may be a predetermined number input by a user. A user may determine the optimum number of data to be included in each bucket through a Pre-processing and use the determined optimum number. According to another example, the same amount of data included in each bucket range may be a value of the total amount of data divided by a predetermined number of ranges that are to be divided. The same amount of data included in each bucket range may be automatically calculated as a value of a variable total amount of data divided by a predetermined number of ranges that is preliminarily input by a user. (The predetermined number=The total amount of data/The number of ranges to be divided). Similarly, the number of ranges to be divided may be extracted through Pre-processing.

According to another example, in the setting the bucket ranges (120), dividing the vector based on statistic information including the average of distances between data that are projected to the vector may set the bucket ranges. The statistic information may include the average of distances between data, deviation of data and quartile of data. In order to improve the performance of processing queries, a user may output the statistic information by performing Pre-processing on the entire data, and the user may use a value of the statistic information producing the most efficient query processing capability as a criterion value for dividing the bucket ranges.

According to another example, the Locality Sensitive Hash bucket range setting method searches may include searching for a region where an interval between data exceeds a predetermined threshold value and performing an adjustment on the bucket range based on the searched region (130). In response to the bucket ranges being divided based on the number of data or the statistic information of data, the buckets may be divided at a region where the data may be more crowded than in other regions. On this ground, a user may perform the adjustment of bucket ranges such that the bucket ranges are divided at a region where data are less crowded than in other regions.

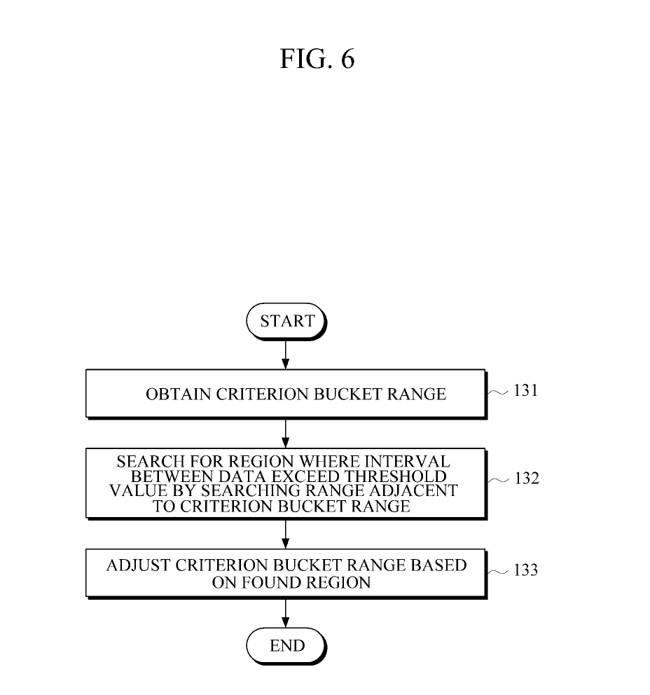

FIG. 6 illustrates an example of adjusting a bucket range of Locality Sensitive Hash. Referring to FIG. 6, operation 130 of performing adjusting on bucket ranges is described. A criterion bucket range to be adjusted is obtained among divided bucket ranges (131). The criterion bucket range represents a bucket range to be adjusted among the already divided buckets. For example, the setting of the criterion bucket range is performed to set at least one of the bucket ranges as the criterion bucket range to be adjusted in the sequence of the first bucket range, the second bucket range and up to a range before the last range. In response to the last range being set as the criterion bucket, the adjustment may be complete. In response to a criterion bucket range being set in operation 131, a bucket range adjacent to the criterion bucket range is searched to find a region where the interval between data exceeds a predetermined threshold value (132). In response to a region having an interval between data exceeding the threshold value existing in the criterion bucket range and the adjacent range, the criterion bucket range is adjusted based on the region found in operation 132 (133). In response to the region where the interval between data exceeds the threshold value being more than one, the criterion bucket range is adjusted based on a region having data most sparsely distributed. In other words, the most sparsely distributed region is a region having data distributed by an interval exceeding the threshold value to the highest degree. After the adjusting has been performed on the criterion bucket, operation 131 of setting the criterion bucket may be performed more than once. In response to no region having an interval between data exceeding the threshold value in a criterion bucket region and a bucket region adjacent to the criterion bucket region existing, the criterion bucket region is not adjusted, the process may return to operation 131, in which a next bucket ranges set as a criterion bucket region, and may perform the above process more than once.

According to another example, the Locality Sensitive Hash bucket range setting method may include generating a range information data structure for the already set bucket ranges (140). is The range information data structure 141 may be range information in the form of a list. In another example, the range information data structure 141 may be implemented in forms such as a table structure, a tree structure, and a hash structure. The generated range information data structure may manage range information of the divided ranges, and may include meta information. The meta information may include information about the amount of data and statistic information for each range bucket. The range information data structure 141 storing the meta information may be used in response to insertion/update/deletion/query of data.

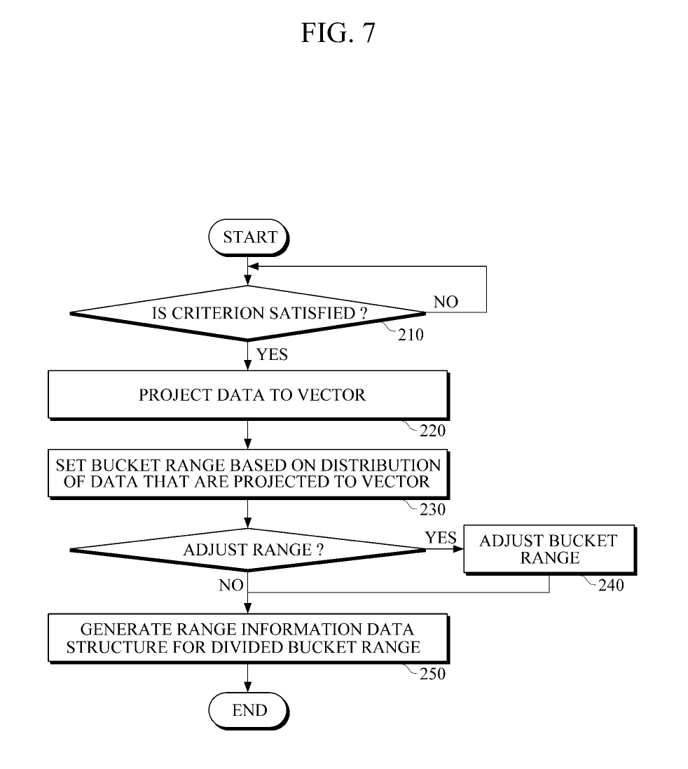

FIG. 7 illustrates an example of updating a bucket range of Locality Sensitive Hash. Referring to FIG. 7, the Locality Sensitive Hash bucket range managing method may include updating a bucket range, which has been already generated, in response to a request being input or a predetermined criterion being satisfied. The updating of the bucket range may be as follows. The Locality Sensitive Hash bucket range managing apparatus 100 may check whether a predetermined criterion for updating the bucket range is satisfied (210). The predetermined criterion may be processed at predetermined periods of time. In another example, the predetermined criterion may be processed in response to the amount of data s included in the bucket range or the static information of data included in the bucket range exceeding a predetermined threshold value. For example, the threshold value may be preliminarily set by a user. In response to the data included in each bucket range exceeding the threshold value due to addition of new data, or the statistic information, such as the average of data distances between data and the deviation of data, being changed due to addition, deletion and update of data, the Locality Sensitive Hash bucket range managing apparatus 100 may reset the bucket range. The predetermined criterion is not limited thereto and may be set by other implementations. For example, the predetermined criterion may be set to automatically update the bucket range whenever a change of data (insertion, update and deletion) occurs. After the updating of the bucket range along with the satisfaction of the criterion, in response to a is predetermined criterion being satisfied, the process returns to the setting of the bucket ranges. That is, data are projected to the vector (220), and then, the bucket range is set based on the distribution of data projected to the vector (230). The bucket range may be adjusted if necessary (240), and range information data structure for the set bucket range is generated (250).

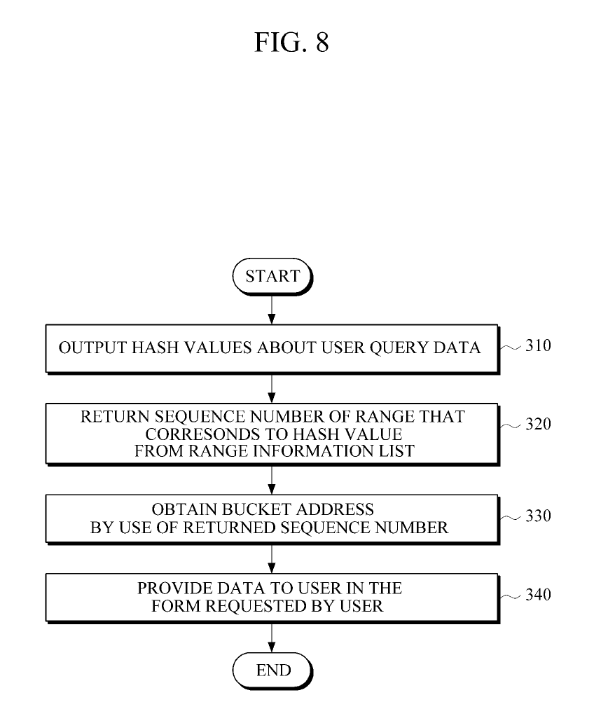

FIG. 8 illustrates an example of processing a query by searching bucket ranges of Locality Sensitive Hash. The Locality Sensitive Hash bucket range managing method may include, upon a query request by a user, processing a query and returning a result in the form requested by the user. Referring to FIG. 8, the processing of query request is described. First, hash values of at least one vector with respect to query data are output (310). The hash values may be output through the above equation. Then, a sequence number (idx) of a bucket range corresponding to the output hash value is returned by searching the range information data structure via a binary search, a sequential search, a tree search, a hash search, etc (320). A bucket address is obtained using the returned sequence number of the bucket range (330). Furthermore, data included in the same bucket address as the bucket address, which has been obtained from each hash table based on the query data, is referred and data is provided to the s user in the form requested by the user (340). For example, the requested form of data may represent ten units of data adjacent to the query or five units of data having a large similarity to the query. That is, a union of data, which are included in buckets each corresponding to the same address as the bucket address output by the bucket address output unit 160, is obtained and the union of data is compared with the query, thereby providing the user with data in the form requested by the user.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in is combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for managing a bucket range of Locality Sensitive Hash, the apparatus comprising:
a range setting unit configured to set bucket ranges of Locality Sensitive Hash by dividing at least one vector based on distribution of data that are projected to the at least one vector.

2. The apparatus of claim 1, wherein the range setting unit sets the bucket range by dividing the at least one vector such that each bucket range comprises substantially the same amount of data.

3. The apparatus of claim 2, wherein the amount of data comprised in the each bucket range corresponds to a value of a total amount of data divided by a predetermined number is of ranges.

4. The apparatus of claim 2, wherein the amount of data comprised in the bucket range corresponds to a predetermined amount input by a user.

5. The apparatus of claim 1, wherein the range setting unit sets the bucket range by dividing the vector based on statistic information including an average of distances between data projected to the at least one vector.

6. The apparatus of claim 1, further comprising a range adjusting unit configured to search for a region where an interval between data exceeds a predetermined threshold value and to adjust the bucket ranges based on the searched region.

7. The apparatus of claim 6, wherein the range adjusting unit sequentially adjusts the bucket ranges, starting from a first bucket range of the bucket ranges, a bucket range to be adjusted and a next bucket range, which is adjacent to the bucket range to be adjusted, are searched and the bucket range to be adjusted is adjusted based on a region having data distributed by an interval exceeding a threshold value, the data comprised in the bucket range to be adjusted and the next range.

8. The apparatus of claim 6, wherein in response to the region where the interval between data exceeds the threshold value being more than one, the range adjusting unit uses a region where an interval between data exceeds the threshold value to a highest degree as a is criterion of adjusting the bucket range.

9. The apparatus of claim 1, further comprising:
a data structure generating unit configured to generate a range information data structure for the bucket range.

10. The apparatus of claim 9, further comprising:
a bucket address output unit configured to output a bucket address with respect to a query data by a user using the range information data structure.

11. The apparatus of claim 10, wherein the bucket address output unit comprises:
a hash value output unit configured to output hash values of the at least one vector based on the query data by the user; and
a range search unit configured to return a sequence number of a bucket range corresponding to the output hash value by searching the range information data structure.

12. The apparatus of claim 1, further comprising a range update unit configured to initiate the range setting unit to reset the bucket range in response to a request being input by a user or a predetermined criterion being satisfied.

13. The apparatus of claim 12, wherein the predetermined criterion is processed by periods of time.

14. The apparatus of claim 12, wherein the predetermined criterion is processed in response to the amount of data comprised in the bucket range or the static information of data is comprised in the bucket range exceeding a predetermined threshold value.

15. A method for managing a bucket range of Locality Sensitive Hash, the method comprising:
projecting data to at least one vector; and
setting bucket ranges of Locality Sensitive Hash by dividing the at least one vector based on distribution of data that are projected to the at least one vector.

16. The method of claim 15, wherein in the setting of the bucket range, the bucket range is set by dividing the vector such that each bucket range comprises substantially the same amount of data.

17. The method of claim 15, wherein in the setting of the bucket range, the bucket range is set by dividing the at least one vector based on statistic information including an average of distances between data that are projected to the at least one vector.

18. The method of claim 15, further comprising searching for a region where an interval between data exceeds a predetermined threshold value and adjusting the bucket ranges based on the searched region.

19. The method of claim 18, wherein in the adjusting of the bucket ranges, in response to the region where the interval between data exceeds the threshold value being more than one, a region where an interval between data exceeds the threshold value to a highest degree is used as a criterion for adjusting the bucket range.

20. The method of claim 15, further comprising generating a range information data structure for the bucket ranges that have been set.

21. The method of claim 20, further comprising, upon a query request by a user, processing a query using the range information data structure and returning a result in a form requested by the user.

22. The method of claim 21, wherein the processing of the query comprises:
outputting hash values of the at least one vector with respect to query data by the user; returning a sequence number of a bucket range corresponding to the output hash value by searching the range information data structure; and
outputting a bucket address using the returned sequence number of the bucket range.

23. The method of claim 15, wherein the projecting operation, the setting operation or a combination thereof is implemented by hardware.

24. A non-transitory computer-readable storage medium for managing a bucket range of Locality Sensitive Hash comprising:
a range setting unit configured to set bucket ranges of Locality Sensitive Hash by dividing at least one vector based on distribution of data that are projected to the at least one vector.
